(19) United States
(12) Patent Application Publication
(10) Pub. No.: US 2005/0102218 A1
(43) Pub. Date: May 12, 2005

(54) Data processing system, methods and computer program for determining the transaction costs for a linked set of stock transactions

(76) Inventors: Timothy Alan Sargent, Naperville, IL (US); John Gerard Wightkin, Naperville, IL (US); Ning Wei, Aurora, IL (US)

Correspondence Address: Cook, Alex, McFarron, Manzo,;Cummings & Mehler, Suite 2850, 200 West Adams, Chicago, IL, 60606, US

(21) Appl. No.: 10/704,892

(22) Filed: Nov. 10, 2003

(51) Int. Cl. G06F 17/60

(52) U.S. Cl. 705/37

(57) ABSTRACT

A data processing system, methods and computer program that determine transaction costs associated with a stock trade. A first portion of the analysis is a trade identification and association portion that identifies previous related trades from a database and orders the trades by ticker identity, time, price and share volume. A second portion determines individual transaction costs, including individual liquidity charge, individual liquidity premium and individual spread charge. A third portion determines cumulative liquidity charge, cumulative liquidity premium and cumulative spread charge. The program that enables the various analyses is also disclosed.

### FIELD OF THE INVENTION

The present invention relates generally to the field of stock transactions. More particularly, the present invention relates to a data processing system, methods and a computer program product for determining the transaction costs associated with the purchase or sale a stock trade.

### BACKGROUND OF THE INVENTION

Isolating and categorizing the costs of stock transactions has received increased attention over the last two decades. The introduction of electronic order routing and the development of competing execution venues have substantially increased the execution options available to equity traders. To judge the effectiveness of a particular execution path or strategy, traders employ a variety of quantitative and qualitative measures.

The most common means of measuring transaction cost is often referred to as ‘implementation shortfall’. This technique simply compares a stock execution price to a fixed benchmark price at some point prior to the trade. Popular benchmark prices include: The closing stock price of the previous business day, the opening price on the day of the execution or the price that prevailed at a pre-determined trade initiation time. The difference between this benchmark price and the actual execution price is referred to as the ‘implementation shortfall’. Such differences can be either positive or negative depending on the price path of the stock over the execution period.

This implementation shortfall is often criticized for being difficult to interpret. The simplicity of the measure does attempt to attribute or isolate specific costs for well-recognized market microstructure elements and behaviors. Little is done to separate the costs associated with demand for liquidity associated with the individual trade from the market timing decision (the impact of prices changes during the time that elapses from the benchmark time/price to the actual execution).

Another technique to better attribute such costs involved identifying the price change due to an individual trade (difference between execution price and trade price just prior to execution). If a series of executions existed in the same stock, this calculation was repeated and then a volume-weighted average of the individual impacts was calculated for the stock. This portion of the implementation shortfall value was described as impact cost or the demand for liquidity. Such techniques provided marginally better attribution, but were still fundamentally flawed. Such measures failed to account for the cumulative imbedded prior change that persisted in the stocks price after each subsequent ‘linked’ execution in the stock.

Another popular and simple measure of trading performance is to compare the execution prior to a volume weighted average price (VWAP) for the stock over some appropriate execution interval. Most common is the VWAP for the trading day that the execution under review took place on. Another popular method is to identify a specific execution period within the day and calculate the VWAP based on just those price and volume characteristics. These measures essentially create a floating benchmark that dilutes the impact of the linked price moves and settles for a transaction-weighted measure for comparison.

There has been a long-felt need for improved an improved data processing system, methods and a computer program product for quantifying the cumulative execution cost of a linked set of buy/sell transactions in a particular stock.

Accordingly, it is a general object of the present invention to provide a new and improved data processing system, methods and computer program product for the comprehensive analysis of transaction costs.

Another object of the present invention is to provide a new and improved data processing system, methods and computer program product for quantifying the cumulative execution cost of a linked set of buy/sell transactions in a particular stock.

Yet another object of the present invention is to provide a data processing system, methods and a computer program product that utilize a unique set of cost identities and a unique algorithm to derive the cumulative execution cost.

### BRIEF SUMMARY OF THE INVENTION

This invention is directed to a new and improved data processing system and methods for providing a through analysis of equity trading costs. This invention is also directed to a computer program for use on a data processor, such as a personal computer, to provide sophisticated analysis of the transaction costs associated with the trades. The results of these analyses allow interested parties to accurately separate the costs of demanding liquidity from the consequences of trade execution timing; and furthermore, distill a unique measure of the cumulative price impact that results from a series of linked executions in the same stock. This execution ‘footprint’ is of significant importance to market participants, but is not readily observable in the marketplace.

The analyses performed by the data processing system and methods for transaction cost measurements consist of three parts. The first is a trade identification and association portion that processes data, such as from a daily tick database, that identifies previous trade prices or a contemporaneous bid/ask spread for each client trade in a client trade database. The searching for the most closely related trade from the daily tick database is done in order of the ticker identity, time, price and share volume. The first search constraint is to determine whether the number of shares in transactions from the tick database is greater than the number of shares traded by the client. The second search constraint is whether trades from the tick database can be identified that were within a predetermined time of the client's trade. The third search constraint is to loosen the time. In each instance, if more than one trade is identified, the first to occur is used in the subsequent analysis.

The second part of the analysis by the data processing system and methods for measuring transaction costs determines individual transaction cost identities, including Individual Liquidity Charge (ILC), Individual Liquidity Premium (ILP), Individual Spread Charge (ISC) and individual timing consequences. If selling or short selling, the ILC is the execution price minus the previous trade price. If buying or buying to cover, the ILC is the previous trade price minus the execution price. In selling or selling short, ILP is zero if the bid price is less than the executed price, but is the executed price minus the bid price if the bid price is greater than the executed price. In buying or buying to cover, ILP is zero if the ask price is greater than the executed price, but is the executed price minus the ask price if the ask price is less than the executed price. Whether selling or buying, ISC is ILC minus ILP, but if ISC is greater than zero, ISC is set to zero and ILC is equal to ILP.

The third part of the analysis by the data processing system and methods for measuring transaction costs determines cumulative transaction cost identities, including Cumulative Liquidity Charge (CLC), Cumulative Liquidity Premium (CLP), Cumulative Spread Charge (CSC) and cumulative timing consequences. In general, CLC is determined by taking the ILC from the current execution and summing it with the last determined CLC. Similarly, CLP is determined by taking the ILP from the current execution and summing it with the last determined CLP. CSC is then CLC minus CLP. However, where the current execution is the first in a linked sequence, CLC=ILC, CLP=ILP and CSC=ISC.

This invention also relates to a computer program for use with a data processor to perform the three parts of the processing and analysis, as disclosed above, and in greater detail below.

The results of these analyses and determinations can be utilized in a variety of ways. These include analyzing the value added by the brokers in executing trades, recreating the market environment that existed during a specific trade, comparing your trades to benchmarks before, during and after the trades, creating periodic reports that provide historical analysis, providing a footprint analysis that compares the individual impact of your trades to the cumulative impact and analyzing individual time-stamped executions. In addition, skilled traders can quickly identify the key drivers of execution costs.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the figures in which like reference numerals identify like elements, and in which:

FIG. 1 illustrates a data processing system that also practices the methods of the present invention and uses the computer program product of the present invention.

FIGS. 2A-2D together constitute a unitary flowchart that illustrates the data processing system and methods utilized in analyzing the transaction costs associated with buying or selling a particular stock in accordance with the present invention. In particular, FIG. 2A illustrates the first part of the trade identification and association analysis. FIG. 2B illustrates the second part that analyzes individual transaction costs. FIGS. 2C-2D illustrate the third part that analyzes cumulative transaction costs.

### DESCRIPTION OF THE PREFERRED EMBODIMENT

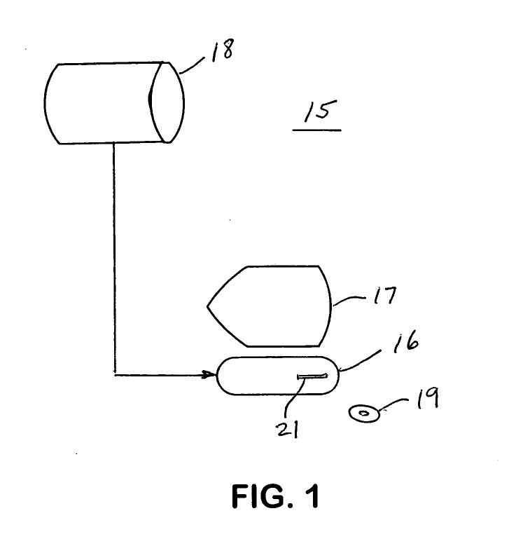

FIG. 1 illustrates a data processing system, generally designated 15, in accordance with the present invention. Data processing system 15 includes a data processor 16 that may be a general purpose computer, a personal computer (PC), or the like. Data processor 16 preferably includes a display 17. Data processor 16 also preferably has a CD unit 21 for reading a computer program that is in computer readable form on a CD 19. Of course, the computer program could be on other computer readable media, downloaded from an internet site, or the like. Data processor 16 is also connected to a database 18, which it may search. The connection may be any of a variety of types including, but not limited to, hard-wired, telephone modem, intranet, internet, satellite communication link, radio frequency (RF) link, or the like.

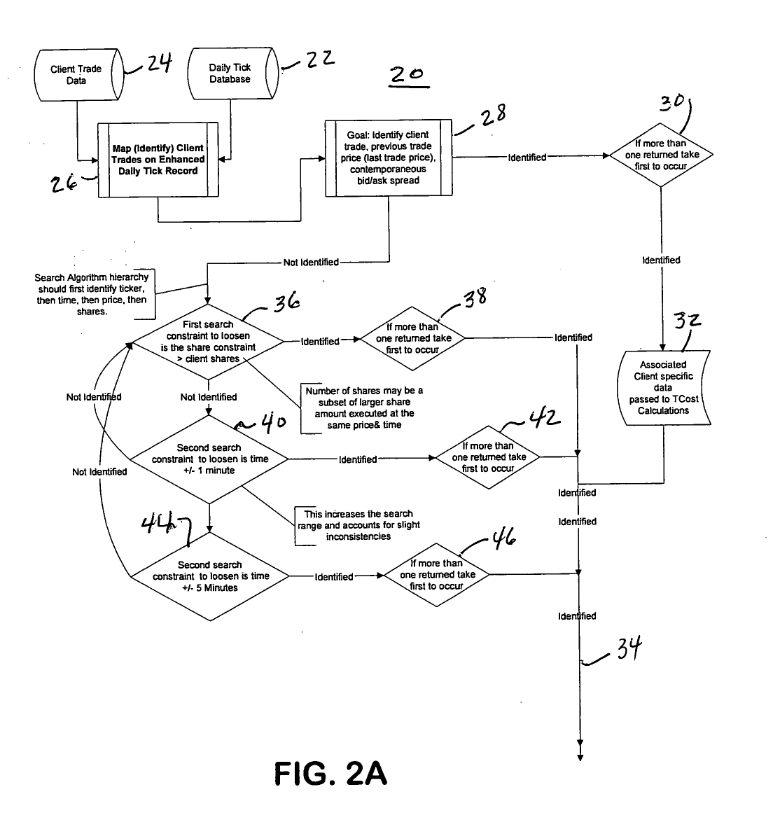

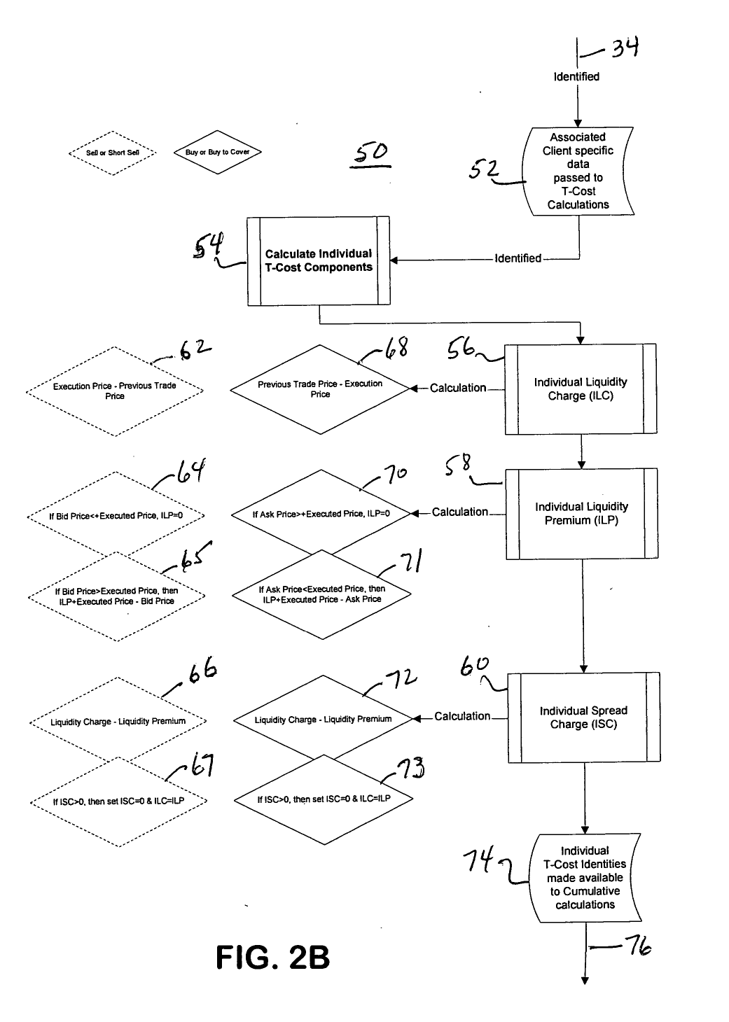

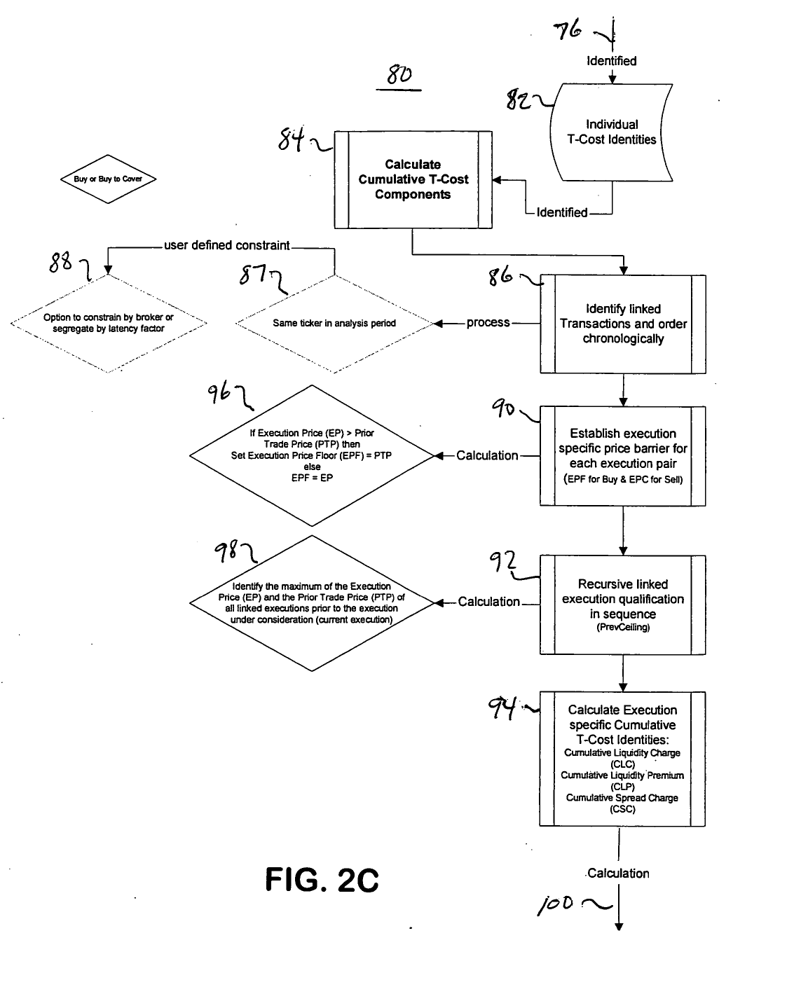

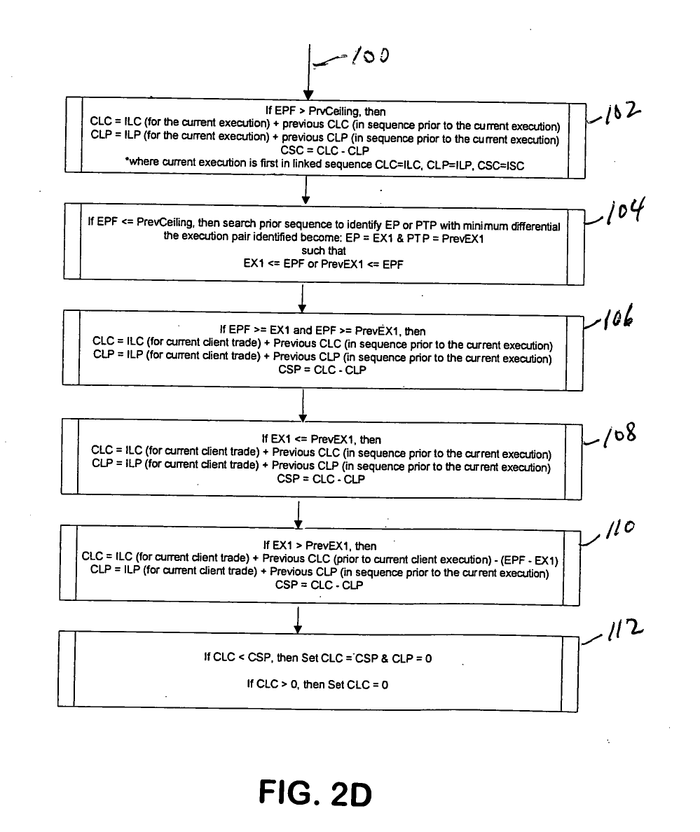

The first part of the analysis performed by the methods and data processing system of the present invention, the trade identification and association portion 20, for measuring and analyzing transaction costs associated with trading a particular stock is shown in FIG. 2A. A daily tick database 22 contains, or has access to, the information associated with a multitude of trades of stocks on various exchanges. For example, the information in or available to daily tick database 22 preferably includes the identity of the ticker, the time of each trade, the price of each trade, the number of shares of each trade and the contemporaneous bid/ask spread for each stock of interest. A client trade database 24 similarly contains, or has access to, all trades associated with a particular client or group of clients. For example, the information in or available to the client trade database preferably includes the time of each trade, the number of shares of each trade, the price of each trade, whether the trade was a buy or a sell and the identity of the exchange on which the trade occurred.

Block 26 receives information from daily tick database 22 and client trade database 24 and maps or identifies client trades, such as on an enhanced daily tick record. Block 28 receives information from block 26 and identifies client trades, previous or last trade prices, and the contemporaneous bid/ask spread for the stocks of interest. Decision block 30 determines if information relating to more than one client transaction is being provided by block 28 and, if so, selects one of the trades such as the first to occur. The information selected by block 30 is passed on to block 32, which passes the data relating to the selected client trade on to the individual transaction cost portion 50 in FIG. 2B via one or more lines 34.

A decision block 36 receives information concerning trades of interest from block 28 and conducts a search for related transactions of the same stock. Preferably, block 36 will use a search algorithm with a hierarchy that first identifies the ticker, then the time, then the price and then the shares. Preferably, block 36 will also use a constraint that the number of shares in the related transaction is greater than the number of shares in the client transaction. However, this constraint may be loosened if desired. It should be noted that the number of shares in the client transaction may be a subset of a larger amount of shares executed at the same time and at the same price. If more than one related transaction is identified by block 36, decision block 38 will select the first transaction to occur and pass the information relating to this transaction to the individual transaction cost part 50 via one or more lines 34.

If block 36 is unable to identify any related transactions, decision block 40 may conduct a second search, such as with a time constraint of plus or minus one minute. This time constraint may be loosened or tailored if desired. This increases the search range and has the tendency to minimize any smaller inconsistencies. If decision block 40 identifies any related transactions within the time constraints, such related transactions are passed to decision block 42. Block 42 selects one of the transactions, such as the first to occur, and passes the information relating to the selected transaction on to the individual cost transaction cost portion 50 via one or more lines 34.

If no related transactions are identified in the search in block 40, decision block 44 may attempt another search for related transactions, such as with a looser time constraint of about plus or minus five minutes. Of course, such time constraints may be varied or tailored as desired, especially in the case of less frequently traded stocks. If block 44 is unsuccessful in identifying any related trades, the search may revert back to block 36 for further searching with more relaxed constraints. However, if related trades are identified by block 44, the trade information is received by decision block 46 which determines if more than one trade is identified. If so, the first trade is selected and the information relating to that trade is pass to the individual transaction cost part 50 via one or more lines 34.

It will be appreciated by those skilled in the art that blocks 26-30 and 36-46 may be performed by the data processor 16. Block 32 may be a buffer or memory, which may be part of the data processor or separate. The data processor 16 may perform the disclosed steps under the guidance of software, such as on CD 19 that supplies directions, criteria, algorithms and the like to the data processor to accomplish the preferred functionality of the trade identification and association portion 20.

The second part of the analysis performed by the methods and data processing system of the present invention, the individual transaction cost portion 50, for measuring and analyzing transaction costs associated with a particular stock is shown in FIG. 2B. The decision blocks in dashed lines in the left hand column of FIG. 2B relate to sell or short sell trades of stock, and the decision blocks in solid lines in the center column of FIG. 2B relate to buy or buy to cover trades.

Individual transaction cost portion 50 receives information from the individual trade and association portion 20 in FIG. 2A via one or more lines 34. This received information may be stored, such as in a buffer or memory 52, and is used to calculate the individual transaction cost components 54 including Individual Liquidity Charge (ILC) 56, Individual Liquidity Premium (ILP) 58 and Individual Spread Charge (ISC) 60.

Individual Liquidity Charge is the price change that occurs between the stock transaction under review and the prior execution price in that stock. When used in conjunction with a benchmark price, this measurement identifies the portion of the price change (between the benchmark price and the execution price) that is the result of satisfying a demand for liquidity (as opposed to market timing). This identity can be attributed to two other measures: Individual Liquidity Premium and Individual Spread Charge. Individual Liquidity Premium results from an execution that occurs outside the prevailing bid/ask spread. This price premium (buy orders)/discount (sell orders) is the result of an excess demand for liquidity or inefficient order routing. Individual Spread Charge is the portion of the Individual Liquidity Charge that is consistent with the prevailing bid/ask spread.

For a sell or short sell trade, the dashed line decision blocks are used to determine ILC 56, ILP 58 and ISC 60. As seen in block 62, ILC is determined as the execution price minus the previous trade price. As further seen in block 64, ILP is set at zero if the bid price is less than the executed price. However, if the bid price exceeds the executed price, then ILP is the executed price minus the bid price (block 65). ISC is ILC minus ILP as seen in block 66; except if ISC is greater than zero, then ISC is set to zero and ILC equals ILP as in block 67.

For a buy or buy to cover trade, the solid line decision blocks are used to determine ILC 56, ILP 58 and ISC 60. As seen in block 68, ILC is determined as the previous trade price minus the execution price. As further seen in block 70, ILP is set at zero if the ask price is greater than the executed price. However, if the ask price is less than the executed price, then ILP is the executed price minus the ask price (block 71). ISC is ILC minus ILP as seen in block 72; except if ISC is greater than zero, then ISC is set to zero and ILC equals ILP as in block 73.

In either the buy or sell trade analysis modes, the individual transaction cost identities ILC, ILP and ISC are stored in a buffer or memory 74 for transmission via one or more lines 76 to the cumulative transaction cost portion 80 shown in FIGS. 2C and 2D. Of course, other information from the trade identification and association portion 20 may also pass to the cumulative transaction cost portion 80 via one or more lines 76. As previously discussed with respect to some blocks in FIG. 2A, blocks 54-73 of FIG. 2B may be performed by a data processor, such as a microprocessor, general purpose computer, personal computer (PC), or the like. Blocks 52 and 74 may be a buffer or memory, which may be part of the data processor or separate. The data processor may perform the disclosed steps or functions under the guidance of software that supplies directions, criteria, algorithms and the like to the data processor to accomplish the preferred functionality of the individual transaction cost portion 50.

Cumulative transaction cost portion 80 in FIG. 2D receives information from individual transaction cost portion 50 in FIG. 2B via one or more lines 76. A buffer or memory 82 may store received information, or only the buffer or memory 74 in FIG. 2B may be used, if desired. This received information is used to calculate the cumulative transaction cost components 84 including Cumulative Liquidity Charge (CLC), Cumulative Liquidity Premium (CLP) and Cumulative Spread Charge (CSC), which are shown in blocks 94 (FIG. 2C) and 102-112 (FIG. 2D).

Cumulative Liquidity Charge is the embedded price change that is the result of a linked series of stock transactions in the same security. These price changes persist through the execution period and are directly associated with the linked series of stock transactions under review. This cumulative measure can be attributed to two other measures: Cumulative Liquidity Premium and Cumulative Spread Charge. Cumulative Liquidity Premium is those embedded costs that result from Individual Liquidity Premiums that persist through the execution period. Cumulative Spread Charge is those embedded costs that result from Individual Spread Charges that persist through the execution period.

However, before the cumulative transaction cost components are determined, the user may identify the linked transactions of interest in block 86 and he/she may place the transactions of interest in chronological order. In addition, the user may limit the analysis to the same ticker, instead of all tickers, in block 87. In block 88, the user may also constrain the analysis by an identified broker or aggregate the linked transactions by a desired latency factor.

Block 90 establishes an execution specific price barrier for each execution pair. This will be an execution price floor (EPF) for a buy trade and an execution price ceiling (EPC) for a sell trade. For example, in block 96, if the execution price (EP) is greater than the prior trade price (PTP), then the execution price floor (EPF) is set equal to PTP. Otherwise, EPF is set equal to EP.

Block 92 performs a recursive linked execution qualification in sequence related to the previous ceiling (PrevCeiling). This identifies the maximum of the execution price (EP) and the prior trade price (PTP) of all linked executions prior to the current execution, as shown in block 98. Block 94 is now ready to begin determination of the cumulative transaction cost identities including CLC, CLP and CSC in blocks 102-112 of FIG. 2D. Block 94 provides information for these calculations via one or more lines 100 to block 102.

With reference to block 102, if the execution price floor (EPF) is greater than the previous ceiling (PrevCeiling), then CLC is equal to ILC (for the current execution) plus CLC (as determined in the sequence prior to the current execution). CLP is equal to the current execution ILP plus the previous execution CLP. CSC is then CLC minus CLP. However, if the current execution is the first in the linked sequence, then the cumulative transaction cost identities are equal to the individual transaction cost identities, as determined in FIG. 2B, namely CLC=ILC, CLP=ILP and CSC=ISC.

As set forth in block 102, if EPF is less than or equal to PrevCeiling, then the prior sequence is searched to identify EP or PTP with the minimum differential. The execution pair identified becomes EP=EX1 and PTP=PrevEX1 such that EX1 is less than or equal to EPF or PrevEX1 is less than or equal to EPF.

In block 106, if EPF is greater than or equal to EX1 and EPF is greater than or equal to PrevEX1, then CLC equals the current ILC plus the previous CLC in sequence prior to the current execution. CLP equals the current ILP plus the previous CLP in sequence prior to the current execution. CSP is equal to CLC minus CLP.

With reference to block 108, if EX1 is less than or equal to PrevEX1, then CLC is equal to the current ILC plus the previous CLC in sequence prior to the current execution. CLP is equal to the current ILP plus the previous CLP in sequence prior to the current execution. CSP is equal to CLC minus CLP.

In block 110, if EX1 is greater than PrevEX1, then CLC is equal to the current ILC plus the previous CLC in sequence prior to the current execution minus (EPF−EX1). CLP is equal to the current ILP plus the previous CLP in sequence prior to the current execution. CSP is equal to CLC minus CLP.

Lastly, in block 112, if CLC is less than CSP, CLC is set equal to CSP and CLP is set to zero. However, if CLC is greater than zero, CLC is set to zero.

The present invention also relates to programming for a data processor to achieve the functionality described in FIGS. 2A-D. A preferred form of the source code for such a computer program is as follows:

1a. Nightly Tick Data (All US Exchanges) Process
Re-order all executions
   Identify the pair of bid offer associated with a particular trade (the pair right before the trade), then retrieve bid price, ask price, bid quote depth, ask quote depth for that particular trade
Calculate bid ask spread

1b. Process Client Executions
Map the client trades on the tape (Price has to be matched under all scenarios)
   Match Level 0: match price, volume, and execution time stamp
   Match Level 1: match price, loose volume (client's executions might be part of market's print), exact time stamp
   Match Level 2: match price, volume, loose time constrain by −1 minute; then find the closest trade on the tape
   Match Level 3: match price, loose volume, loose time constrain by −1 minute; then find the closest trade on the tape
   Match Level 4: match price, volume, loose time constrain by +1 minute; then find the closest trade on the tape
   Match Level 5: match price, loose volume, loose time constrain by +1 minute; then find the closest trade on the tape
   Match Level 6: match price, volume, loose time constrain by −2 minute; then find the closest trade on the tape
   Match Level 7: match price, loose volume, loose time constrain by −2 minute; then find the closest trade on the tape
   Match Level 8: match price, volume, loose time constrain by +2 minute; then find the closest trade on the tape
   Match Level 9: match price, loose volume, loose time constrain by +2 minute; then find the closes trade on the tape
   Match Level 10: match price, volume, loose time constrain by −15 minute; then find the closest trade on the tape
   Match Level 11: match price, loose volume, loose time constrain by −15 minute; then find the clostst trade on the tape
   Match Level 12: match price, volume, loose time constrain by +15 minute; then find the closest trade on the tape
   Match Level 13: match price, loose volume, loose time constrain by +15 minute; then find the closest trade on the tape

Identify the execution prior to the client execution (the one right before the client's trade), then identify the bid price, ask price, bid quote depth, ask quote depth, and bid ask spread associated with that prior trade

2. Calculate the TCost components (Unique Transaction Cost Measurement)
Calculate the individual Tcost components first Individual Liquidity Charge—ILC (has to be 0 or negative number)
For Buy or Buy to Cover:
Individual Liquidity Charge=Previous Trade Price−Executed Price
For Sell or Short Sell:
Individual Liquidity Charge=Executed Price−Previous Trade Price
Individual Liquidity Premium-ILP
For Buy or Buy to Cover.
If Ask Price <=Executed Price, then Liquidity Premium=0
If Ask Price<Executed Price, then Liquidity Premium=Ask Price−Executed Price For Sell or Short Sell:
If Bid Price <=Executed Price, then Liquidity Premium=0
If Bid Price>Executed Price, then Liquidity Premium=Executed Price−Ask Price
Individual Spread Charge—ISC
Individual Spread Charge=Liquidity Charge−Liquidity Premium
If individual Spread Charge>0, then set
Individual Spread Charge=0
Liquidity Charge=Liquidity Premium

3. Calculate the cumulative Tcost components
For Buy or Buy to Cover:
   (1). Compare current executed price with prior trade price
   If current executed price with prior trade price
      Set Floor=prior trade price Else
      Set Floor=executed price
   (2). Identify the maximum of both the client's executed price and the price prior to the client executors for all the client's trades executed before the current execution (PrevCalling)
   (3). Determine the cumulative Tcost values:
      Cumulative Liquidity Charge—CLC
      Cumulative Liquidity Premium—CLP
      Cumulative Spread Charge—CSC
      If Floor>PrevCeiling, then
      CLC=ILC (for current client trade)+Previous CLC (prior to current client trade)
      CLP=ILP (for current client trade)+Previous CLP (prior to current client trade)
      CSP=CLC−CLP
      If Floor>=PrevCeiling, then identify the closest trade (traded @ EX1) and the trade prior to this closest trade (traded @ PrevEX1), so that EX1<=Floor or PrevEX1<=Floor
         If Floor >=EX1 and Floor >=PrevEX1, then
      CLC=ILC (for current client trade)+Previous CLC (prior to current client trade)
      CLP+ILP (for current client trade)+Previous CLP (prior to current client trade)
      CSP=CLC−CLP
      If Ex1<=PrevEX1, then
      CLC=ILC (for current client trade)+Previous CLC (prior to current client trade)(Floor−EX1)
      CLP=ILP (for current client trade)+Previous CLP (prior to current client trade)
      CSP=CLC−CLP
      If CLC<CSP
         Set CLC=CSP
         CLP=0
      If CLC>0
         Set CLC=0

For Sell or Short Sell:
(1) Compare current executed price with prior trade price
   If current executed price with prior trade price
      Set Ceiling=prior trade price
   Else
      Set Ceiling=executed price
(2) Identify the minimum of both the client's executed price and the price prior to the client executions for all the client's trades executed before the current execution (PrevFloor)
(3) Determine the cumulative Tcost values:
   Cumulative Liquidity Charge—CLC
   Cumulative Liquidity Premium—CLP
   Cumulative Spread Charge—CSC
   If Ceiling<PrevFloor, then
   CLC=ILC (for current client trade)+Previous CLC (prior to current client trade)
   CLP=ILP (for current client trade)+Previous CLP (prior to current client trade)
   CSP=CLC−CLP
   If Ceiling<=PrevFloor, then identify the closest trade (traded @ EX1) and the trade prior to this closest trade (traded @ PrevEX1), so that
   EX<=Ceiling or PrevEX1>=Ceiling
   If Ceiling <=EX1 and Ceiling <=PrevEx1, then
   CLC=ILC (for current client trade)+Previous CLC (prior to current client trade)
   CLP=ILP (for current client trade)+Previous CLP (prior to current client trade)
   CSP=CLC−CLP
   If EX1>=PrevEX1, then
   CLC=ILC (for current client trade)+Previous CLC (prior to current client trade)
   CLP=ILP (for current client trade)+Previous CLP (prior to current client trade)
   CSP=CLC−CLP
   If EX1<Prev EX1, then
   CLC=ILC (for current client trade)+prior CLC (prior to current client trade)−(EX1−Ceiling)
   CLP=ILP (for current client trade)+Previous CLP (prior to current client trade)
   CSP=CLC−CLP
   If CLC<CSP
      Set CLC=CSP
         CLP=0
      If CLC>0
         Set CLC=0

The steps in the foregoing program have previously been described above with respect to the various blocks in FIGS. 2A-D.

The results of these analyses and determinations performed by the data processing system, methods and computer program of the present invention can be utilized in a variety of ways. These include analyzing the value added by the brokers in executing trades, recreating the market environment that existed during a specific trade, comparing your trades to benchmarks before, during and after the trades, creating periodic reports that provide historical analysis, providing a footprint analysis that compares the individual impact of your trades to the cumulative impact and analyzing individual time-stamped executions. In addition, with the benefit of the analysis provided by the present invention, skilled traders can quickly identify the key drivers of execution costs.

While particular embodiments of the invention have been shown and described, it will be obvious to those skilled in the art that changes and modifications may be made therein without departing from the invention in its broader aspects.

1. A method for determining the transaction costs associated with a stock trade, said method comprising the steps of:
identifying previous trade information from information stored in a database;
determining the individual transaction costs associated with said stock trade; and
determining the cumulative transaction costs associated with said stock trade.

2. The method for determining the transaction costs associated with a stock trade in accordance with claim 1, wherein the step of identifying previous trade information includes the step of:
ordering the previous trade information by ticker identity, time, price and share volume.

3. The method for determining the transaction costs associated with a stock trade in accordance with claim 1, wherein the step of identifying previous trade information includes the step of:
searching the database with a constraint that any related trades must be for trades of larger share volume than for said stock trade.

4. The method for determining the transaction costs associated with a stock trade in accordance with claim 1, wherein the step of identifying previous trade information includes the step of:
searching the database with a constraint that any related trades must be for trades within a predetermined time of said stock trade.

5. The method for determining the transaction costs associated with a stock trade in accordance with claim 4, wherein the step of identifying previous trade information includes the step of:
subsequently searching the database again with a looser time constraint.

6. The method for determining the transaction costs associated with a stock trade in accordance with claim 1, wherein the step of determining the individual transaction costs for a stock trade includes the steps of:
determining an individual liquidity charge;
determining an individual liquidity premium; and
determining an individual spread charge.

7. The method for determining the transaction costs associated with a stock trade in accordance with claim 1, wherein the step of determining the cumulative transaction costs for a stock trade includes the steps of:
determining a cumulative liquidity charge;
determining a cumulative liquidity premium; and
determining a cumulative spread charge.

8. A data processing system for determining the transaction costs associated with a stock trade, said data processing system comprising:
a database for storing information relating to previous stock trades;
means for identifying previous trade information from information stored in a database;
means for determining the individual transaction costs associated with said stock trade; and
means for determining the cumulative transaction costs associated with said stock trade.

9. The data processing system for determining the transaction costs associated with a stock trade in accordance with claim 8, wherein the means for identifying previous trade information further comprises:
means for ordering the previous trade information by ticker identity, time, price and share volume.

10. The data processing system for determining the transaction costs associated with a stock trade in accordance with claim 8, wherein the means for identifying previous trade information further comprises:
means for searching the database with a constraint that any related trades must be for trades of larger share volume than for said stock trade.

11. The data processing system for determining the transaction costs associated with a stock trade in accordance with claim 8, wherein the means for identifying previous trade information further comprises:
means for searching the database with a constraint that any related trades must be for trades within a predetermined time of said stock trade.

12. The data processing system for determining the transaction costs associated with a stock trade in accordance with claim 11, wherein the means for identifying previous trade information further comprises:
means for subsequently searching the database again with a looser time constraint.

13. The data processing system for determining the transaction costs associated with a stock trade in accordance with claim 8, wherein the means for determining the individual transaction costs for a stock trade further comprises:
means for determining an individual liquidity charge;
means for determining an individual liquidity premium; and
means for determining an individual spread charge.

14. The data processing system for determining the transaction costs associated with a stock trade in accordance with claim 8, wherein the means for determining the cumulative transaction costs for a stock trade further comprises:
means for determining a cumulative liquidity charge;
means for determining a cumulative liquidity premium; and
means for determining a cumulative spread charge.

15. A computer program product for determining transaction costs associated with a stock trade, the computer program product comprising:
a computer readable medium; and
instructions stored on the computer readable medium to cause a data processor to:
identify previous trade information from information stored in a database;
determine the individual transaction costs associated with said stock trade; and
determine the cumulative transaction costs associated with said stock trade.

16. The computer program product for determining the transaction costs associated with a stock trade in accordance with claim 15, wherein the instructions stored on the computer readable medium cause the data processor to:
order the previous trade information by ticker identity, time, price and share volume.

17. The computer program product for determining the transaction costs associated with a stock trade in accordance with claim 15, wherein the instructions stored on the computer readable medium cause the data processor to:
search the database with a constraint that any related trades must be for trades of larger share volume than for said stock trade.

18. The computer program product for determining the transaction costs associated with a stock trade in accordance with claim 15, wherein the instructions stored on the computer readable medium cause the data processor to:
search the database with a constraint that any related trades must be for trades within a predetermined time of said stock trade.

19. The computer program product for determining the transaction costs associated with a stock trade in accordance with claim 18, wherein the instructions stored on the computer readable medium cause the data processor to:
subsequently search the database again with a looser time constraint.

20. The computer program product for determining the transaction costs associated with a stock trade in accordance with claim 15, wherein the instructions stored on the computer readable medium cause the data processor to:
determine an individual liquidity charge;
determine an individual liquidity premium; and
determine an individual spread charge.

21. The computer program product for determining the transaction costs associated with a stock trade in accordance with claim 15, wherein the instructions stored on the computer readable medium cause the data processor to:
determine a cumulative liquidity charge;
determine a cumulative liquidity premium; and
determine a cumulative spread charge.
